(19) United States
(12) Patent Application Publication
(10) Pub. No.: US 2005/0264095 A1
(43) Pub. Date: Dec. 1, 2005

(54) Tire and wheel assembly

(76) Inventor: Frank August Eberhard, Essexville, MI (US)

Correspondence Address: WARNER NORCROSS & JUDD LLP, 900 FIFTH THIRD CENTER, 111 LYON STREET, N.W., GRAND RAPIDS, MI, 49503-2487, US

(21) Appl. No.: 10/853,614

(22) Filed: May 25, 2004

(51) Int. Cl. B60B 21/00

(52) U.S. Cl. 301/95.101

(57) ABSTRACT

A wheel is provided with a corrosion resistant coating, such as a powder coating. The powder coating of the wheel in interaction with the interior of the tire creates a virtual inner tube for the wheel, thereby improving the air retention characteristics of the wheel and tire assembly. Alternatively, the wheel could be provided a flexibly resilient plastic strip, such as an adhesive backed urethane, to cover the area where the tire is in contact with the wheel.

### BACKGROUND OF THE INVENTION

This invention relates to tire and wheel assemblies for automobiles, and more particularly to an improved interface between the wheel and tire.

Aluminum wheels have become increasing popular for use on automobiles. They have several advantages over steel wheels. Aluminum wheels do not rust, and as a consequence, they are virtually maintenance free. The appearance of aluminum wheels is considered by many to be superior to that of a steel wheel. Aluminum wheels are lighter than steel, reducing the overall weight of the vehicle, thereby making the vehicle more fuel efficient. For these, and other reasons, the aluminum wheel is considered to be superior to that of a steel wheel.

Climate, contaminants and corrosion deteriorate the interface between the wheel and tire. Aluminum wheels are susceptible to an electro-chemical reaction at the junction of the rubber tire bead and the aluminum wheel. Water, road salt and other roadside substances cause the formation of an aluminum oxide layer at the rubber/metal junction. As the layer builds, cracks in the aluminum oxide layer form small air passages that result in the tire losing pressure. This situation is accelerated in colder northern climates.

Low tire pressure contributes to accidents, tire “blow-outs”, poor gas economy, and premature tire wear. In order to maintain the integrity of the tire assembly, the tire seal must not be compromised. The wheel contact surface must not be damaged, and the air pressure in the tire should be maintained at a desired level. If not, the tire assembly will deteriorate and eventually fail. Ultimately, control of the vehicle will be lost and the possibility of an accident is increased.

There are no current alternatives to restoring a permanent seal between the tire and rim. Periodic cleaning of the wheel-to-tire surfaces when the aluminum-oxide layer forms as a temporary measure to maintain the pressure of the tire. Cleaning has been found to reduce the loss of air pressure, but the procedure to accomplish this is time consuming and complex. The tire must be dismounted and the wheel burnished with a rotary disk grinder before it is reinstalled on the wheel. Obviously, servicing the wheels in this manner is extremely inconvenient. Consequently, an improved method of improving the seal between the tire and wheel is highly desirable.

Thus, an improved device for insuring a seal between the tire and wheel is highly desirable.

### SUMMARY OF THE INVENTION

A wheel is provided with a corrosion resistant coating. This could be a powder coating but is not necessarily limited to a powder coating. The coating of the wheel in interaction with the bead surfaces of the tire and the air pressure in the tire and wheel assembly creates a virtual inner tube for the wheel, thereby maintaining the design characteristics of the wheel and tire assembly. For aftermarket applications, the wheel could be provided a flexible, adhesive-backed resilient plastic strip to cover the area where the tire is in contact with the wheel.

These and other objects, advantages and features of the invention will be more readily understood and appreciated by reference to the detailed description of the drawings.

### BRIEF DESCRIPTION OF THE DRAWINGS

FIG. 1 shows a wheel assembly.

### DETAILED DESCRIPTION OF THE DRAWINGS

The reason for the tire deflation is due to the build of scaly layers of aluminum oxide. As is well known, the corrosion of aluminum causes a layer of aluminum oxide to form on the surface. The aluminum oxide clings to the surface of the aluminum. Very quickly, a hard layer of aluminum oxide covers the metal and protects the aluminum metal beneath. When exposed to water, the aluminum no longer corrodes since it is protected by a layer of aluminum oxide.

However, in winter weather, the wheels are exposed to salt and other chemicals used to remove snow and ice from streets. Salt water is extremely corrosive to aluminum. Salt water causes the aluminum oxide layer to be stripped from the wheel, exposing another layer of aluminum. This aluminum layer also oxidizes, and is then subsequently stripped away by more salt water. The motion of the tire bead against the wheel results in the scaling and cracking of the layers of aluminum oxide. When the aluminum oxide layers crack, air passages are created allowing the pressurized air within the tire to be released, causing deflation of the tire.

In order to eliminate this problem, the portion of the wheel in contact with the tire is coated with a corrosion resistant overcoat at the time of manufacturing. The corrosion resistant overcoat could be a powder coating. Additionally, the corrosion resistant coating would be an electrical insulator and thereby electrically isolate the tire from the aluminum wheel.

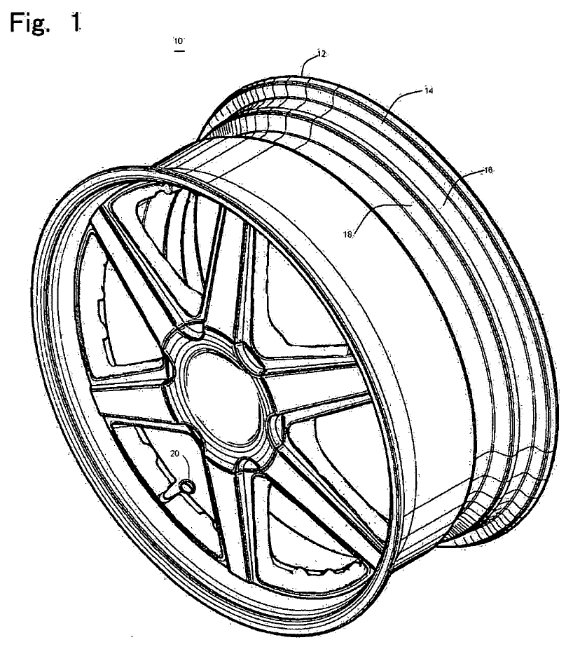

FIG. 1 shows wheel 10. Wheel 10 includes flange 12, upper collar 14, plateau 16, base collar 18 and valve stem area 20. A tire having a bead affixed to wheel 10 would contact upper collar 14. Therefore, upper collar 14 would be provided with a corrosion resistant overcoat such as powder coating for aesthetic as well as protective reasons. Valve stem area 20 would also be provided with a corrosion resistant overcoat. Alternatively, the interior or the entire wheel itself could be provided with a corrosion resistant overcoat such as a powder coating.

Coating of the wheel between the bead areas creates a virtual inner tube to prevent loss of air, with the virtual inner tube being formed by the tire casing and the inside coated area of the wheel. With such an arrangement, the possibility of corrosion between the wheel and the tire as well as between the wheel and the valve stem is eliminated. The valve stem/wheel seal is incorporated into the wheel portion and thereby becomes an integral part of the assembly.

The assembly eliminates the possibility of a corrosion layer building up between the tire and wheel assembly. No change to the manufacturing process would be required other than the inclusion of the step of powder coating part or all of the wheel. While the wheel is normally anodized to prevent corrosion, it would be better to powder coat the wheel assembly rather than anodize.

If the entire wheel were powder coated both inside and outside, additional protection would be afforded the wheel by preventing corrosion caused by the steel weight clamps biting into the aluminum or magnesium wheel when the wheels were balanced. Additionally, casting porosity problems would be eliminated.

For existing tire and wheel assemblies, the tire would be dismounted from the wheel, and the surfaces where the tire bead and the wheel come into contact would be cleaned, preferably with a rotary plastic abrasive wheel. The wheel to tire contact areas would be lined with an adhesive-backed urethane or other flexibly resilient plastic strip. The tire would then be re-mounted and inflated.

Coating of the rim provides several advantages. Coating the existing rim surfaces re-establishes an original lasting seal between the tire and rim. It would provide oxidation prevention of the entire rim assembly, including the seal interface point. Coating the entire rim also eliminates corrosion in the area where the steel “teeth” of the wheel weights attempt to “bite” into the wheel to balance it and hold it in place. Steel-to-aluminum contact invites electrolytic reaction. Finally, coating the entire rim at the manufacturing process level would be optimal and enhance the aesthetics of the tire.

The invention is intended to allow the tire and wheel assembly to remain at its preferred, design state. A tire mounted on a wheel treated or configured as hereinafter described will maintain air pressure at the level specified by the tire and automobile manufacturer.

To prove the efficacy of the isolation of the wheel from the tire, a test was conducted. Tires on an automobile were pressurized to 36 psi (pounds per square inch). Pressure was checked twice a week for four months on all four tires on the automobile. The automobile was driven in normal driving conditions. Tire pressure dropped anywhere from 22 to 26 psi from one measurement to the next.

At the conclusion of the four month period, the tires were dismounted. The beads of the tire were cleaned with soapy water. The bead surfaces of the wheels and the valve-mounting hole were cleaned with a wire wheel mounted to a right-angle drive hand-held grinder. The wheel was then wiped cleaned and powder coated. The same tires were remounted on the wheels pressurized to 36 psi, and placed onto the same automobile. The car was driven as before. The pressure in the tire was checked weekly for three months. The pressure remained constant for three months.

The method of coating the wheel with a corrosion resistant overcoat was proven to be an effective method of preventing the depressurization of the tires, and the resulting possibility of a catastrophic failure of the tire and wheel assembly at high speeds is reduced.

The above description is of the preferred embodiment. Various alterations and changes can be made without departing from the spirit and broader aspects of the invention as defined in the appended claims, which are to be interpreted in accordance with the principles of patent law including the doctrine of equivalents. Any references to claim elements in the singular, for example, using the articles “a,” “an,” “the,” or “said,” is not to be construed as limiting the element to the singular.

1. An aluminum wheel for mounting a tire thereon, the wheel having a collar where the tire makes contact with the wheel, the collar being coated with a corrosion resistant overcoat.

2. The aluminum wheel of claim 1 where the corrosion resistant overcoat is a powder coating.

3. A wheel and tire assembly comprising:
a wheel, the wheel having a corrosion resistant coating on the portion of the wheel coming into contact with the tire; and
a tire, wherein the tire and the corrosion resistant coating form a virtual inner tube.

4. The wheel and tire assembly of claim 3 where the corrosion resistant coating covers the entire portion of the wheel contained within the tire.

5. The wheel and tire assembly of claim 3 where the valve stem area is provided with a corrosion resistant coating.

6. The wheel and tire assembly of claim 5 where the corrosion resistant coating covers the entire wheel.

7. The wheel and tire assembly of claim 5 where the corrosion resistant coating is a powder coating.

8. The wheel and tire assembly of claim 4 where the corrosion resistant coating is a flexibly resilient plastic strip.

9. The wheel and tire assembly of claim 8 where the flexibly resilient plastic strip is an adhesive-backed urethane.

10. The wheel and tire assembly of claim 4 where the corrosion resistant coating is an electrical insulator.
